(19) United States
(12) Patent Application Publication
(10) Pub. No.: US 2011/0297130 A1
(43) Pub. Date: Dec. 8, 2011

(54) Fuel Converter

(76) Inventors: Delbert L. Weller, Pana, IL (US); Martin R. Eden, Quincy, IL (US)

(21) Appl. No.: 12/796,300

(22) Filed: Jun. 8, 2010

(51) Int. Cl. F02G 5/00

(52) U.S. Cl. 123/557

(57) ABSTRACT

A fuel converter includes a housing having a hollow first end configured to be coupled to a fuel line, a hollow second end configured to be coupled to a fuel system downstream of the housing first end, a heat input area, a plurality of capillaries spaced about the heat input area. The housing includes an input manifold providing passage between the hollow first end and the capillaries and an output manifold providing passage between the capillaries and the hollow second end. Each capillary includes a diameter that is smaller than a diameter of a channel defined by the hollow first end. The fuel converter includes a heating element in the heat input area for heating fuel passing through the capillaries past the fuel's vaporization point to separate the fuel into fuel components while not igniting either of the fuel or the fuel components.

### BACKGROUND OF THE INVENTION

This invention relates generally to fuel devices for combustion engines and, more particularly, to a device for converting traditional fuel into lighter fuels by separating it by heating it beyond a vaporization point yet without igniting either the fuel or the components.

Despite the overwhelmingly positive impact and usefulness of a traditional combustion engine, the inefficiencies of such engines have become well known. In large part, the use of traditional gasoline is the culprit for the overall inefficiency. While smaller and lighter fuel components such as hydrogen or methane gas may be more efficient in that they promote more complete burning, such gases are more volatile to transport or store for use in a vehicle engine. The use of these more efficient fuels in a combustion engine would result in less energy being lost in engine exhaust due to incomplete burning.

Various devices have been proposed in the prior art for converting traditional fuel to lighter and more efficient fuels. Although assumably effective for their intended purposes, the existing devices and proposals do not adequately “crack” traditional gas molecules into smaller components from inside an engine so as to obtain the efficiencies thereof without the risks and inconvenience of transporting converted fuels prior to use in an engine.

Therefore, it would be desirable to have a fuel converter that breaks down traditional fuel into smaller, lighter fuel components inline within a combustion engine by superheating the fuel. Further, it would be desirable to have a fuel converter that cracks fuel molecules above a vaporization point without igniting either the traditional fuel or resulting fuel components. In addition, it would be desirable to have a fuel converter that improves the efficiency of an engine by generating more power while using less quantity of fuel.

### SUMMARY OF THE INVENTION

Accordingly, a fuel converter according to the present invention includes a housing having a hollow first end configured to be coupled to a fuel line, a hollow second end configured to be coupled to a fuel system downstream of the housing first end, a heat input area, a plurality of capillaries spaced about the heat input area. The housing includes an input manifold providing passage between the hollow first end and the capillaries and an output manifold providing passage between the capillaries and the hollow second end. Each capillary includes a diameter that is smaller than a diameter of a channel defined by the hollow first end. The fuel converter includes a heating element in the heat input area for heating fuel passing through the capillaries past the fuel's vaporization point to separate the fuel into fuel components while not igniting either of the fuel or the fuel components.

A general object of this invention is to provide a fuel converter for breaking down gasoline fuel in a combustion engine into smaller and lighter gases.

Another object of this invention is to provide a fuel converter, as aforesaid, that improves the efficiency of a combustion engine by promoting clean and thorough burning of fuel.

Still another object of this invention is to provide a fuel converter, as aforesaid, that breaks down fuel molecules by heating the fuel above a vaporization point without igniting either the traditional fuel or resulting fuel components.

Yet another object of this invention is to provide a fuel converter, as aforesaid, that converts fuel from within a combustion engine so that the converted fuels do not need to be stored or transported.

A further object of this invention is to provide a fuel converter, as aforesaid, that superheats traditional fuel under pressure.

Other objects and advantages of the present invention will become apparent from the following description taken in connection with the accompanying drawings, wherein is set forth by way of illustration and example, embodiments of this invention.

### BRIEF DESCRIPTION OF THE DRAWINGS

FIG. 1 is a perspective view of a fuel converter according to a preferred embodiment of the present invention;

FIG. 2 is a side view of the fuel converter as in FIG. 1;

FIG. 3a is a top view of the fuel converter as in FIG. 1;

FIG. 3b is a sectional view taken along line 3b-3b of FIG. 3a;

FIG. 4 is an exploded view of the fuel converter as in FIG. 1; and

FIG. 5 is a block diagram of the fuel converter components according to the present invention.

### DESCRIPTION OF THE PREFERRED EMBODIMENT

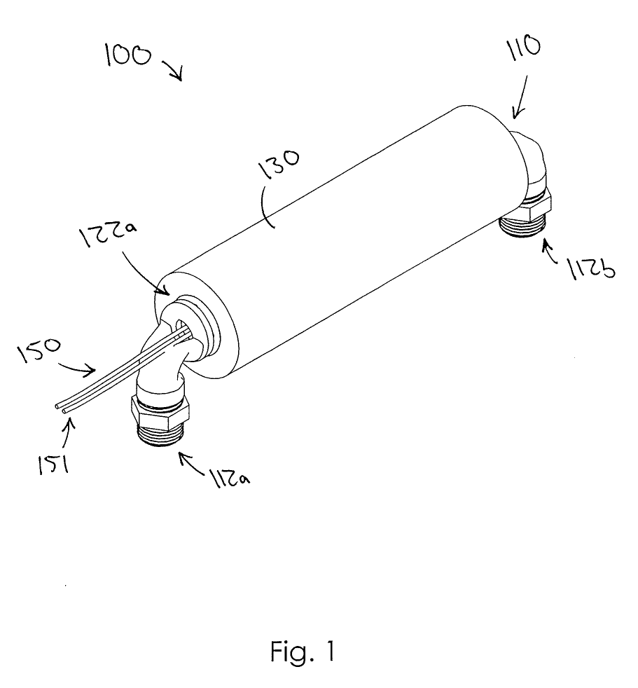

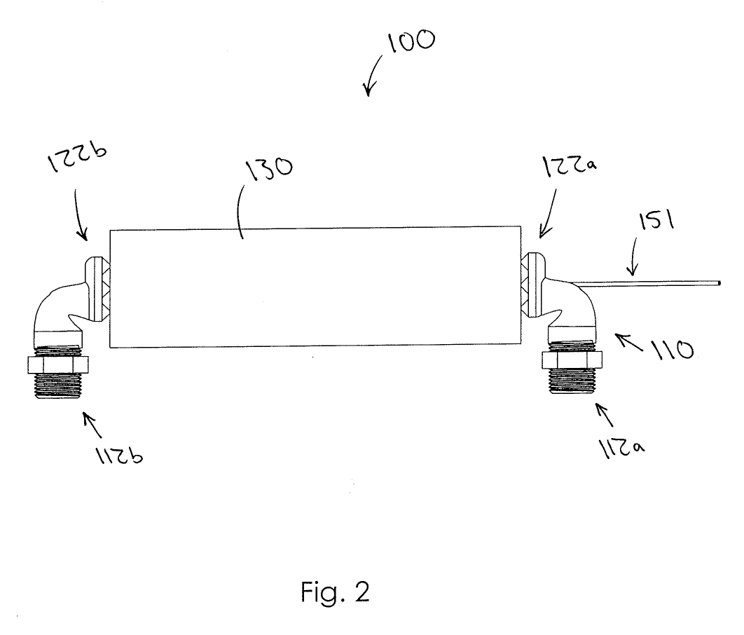

Fuel converters according to the present invention will now be described in detail with reference to FIGS. 1 through 5 of the accompanying drawings. More particularly, a fuel converter 100 according to one embodiment includes a housing 110 and a heating element 150.

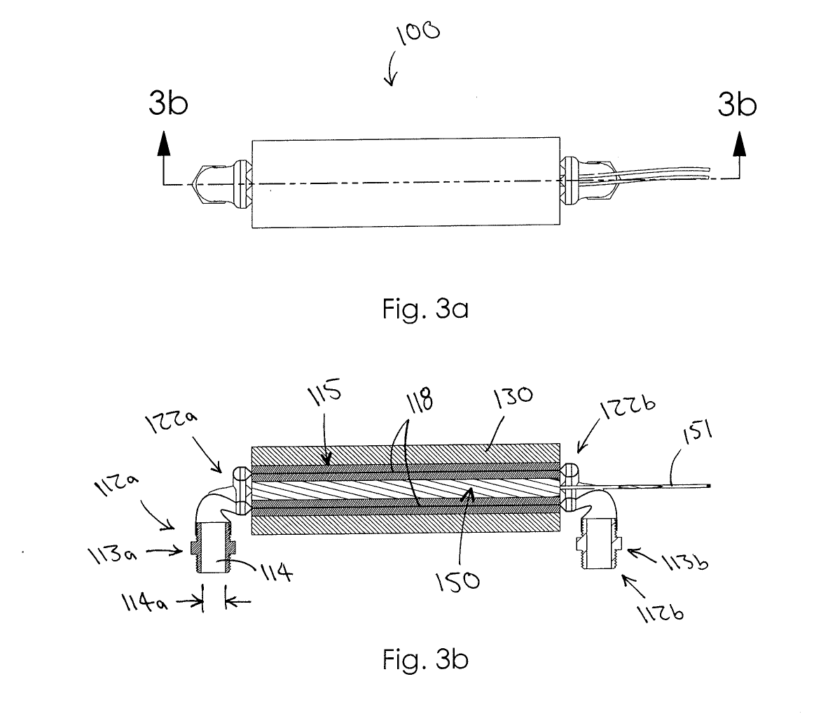

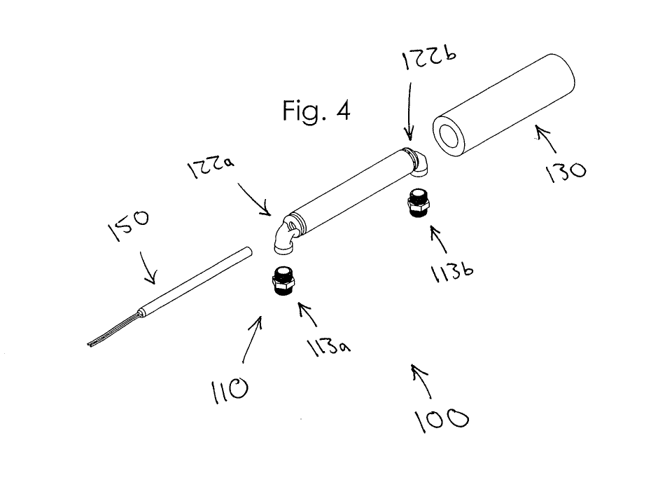

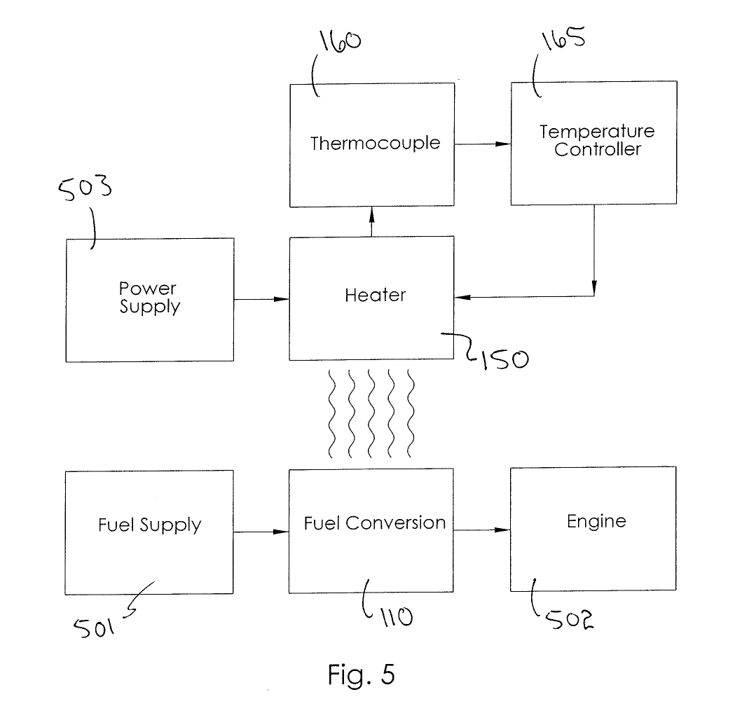

The housing 110 (FIGS. 1 through 4) has a hollow first end 112a configured to be coupled to a fuel line 501 (FIG. 5) and a hollow second end 112b configured to be coupled to a fuel system downstream of the first end 112a (eventually leading to internal combustion engine 502, shown in FIG. 5). Removable fittings 113a, 113b (FIGS. 3b and 4) may provide structure for coupling, or coupling may be otherwise accomplished (as will be apparent to those skilled in the art). A diameter 114a of a channel 114 defined by the hollow first end 112a is shown in FIG. 3b.

As best shown in FIG. 3b and FIG. 4, the housing 110 further includes a heat input area 115 and a plurality of capillaries 118 spaced about the heat input area 115. Each capillary 118 has a diameter that is smaller than the diameter 114a of the channel 114. While various numbers of capillaries 118 may be included, two capillaries 118 appear in the cross section view of FIG. 3b. It may be desirable for the capillaries 118 to be generally linear and generally equi-radially spaced about the heat input area 115, though other configurations may alternately be used. The capillaries 118 are formed in a conductive material (e.g., aluminum, copper, or other metal) surrounding the heat input area 115.

An input manifold 122a provides passage between the hollow first end 112a and the capillaries 118, and an output manifold 122b provides passage between the capillaries 118 and the hollow second end 112b. The housing 110 may, for example, be generally cylindrical with a circular cross-section perimeter between the input and output manifolds 122a, 122b. As shown in FIG. 3b, insulation 130 may surround at least a portion of the housing 110, such as the area between the input and output manifolds 122a, 122b.

Best shown in FIG. 3b and FIG. 4, the heating element 150 is positioned in the heat input area 115 for heating fuel (e.g., gasoline) passing through the capillaries 118 past the fuel's vaporization point to separate the fuel into fuel components (e.g., methane, perhaps hydrogen, etc.) while not igniting either of the fuel or the fuel components. The heating element 150 shown in the drawings is a resistive heating element having electrical wiring 151 that extends to a power source 503 (shown in FIG. 5; for example, an automobile battery) for powering the heating element 150. Other heat sources may alternately or additionally be used, such as waste heat from an internal combustion engine's combustion process. In some embodiments, the heating element 150 is removably positioned in the heat input area 115, while instead being permanently positioned in the heat input area 115 in other embodiments.

Turning to FIG. 5, a sensor 160 (also referred to as a thermocouple) may be included to determine a temperature of (for example): fuel in at least one of the capillaries 118, fuel components in at least one of the capillaries 118, the heat input area 115 of the housing 110, and/or the heating element 150. The sensor 160 may provide the temperature data to a controller 165 that is in communication with the heating element 150, so that the controller 165 may adjust a heat output of the heating element 150 using data from the sensor 160 and a target temperature.

In use, fuel passing through the fuel converter 100 is converted into fuel components for powering the internal combustion engine 502 (FIG. 5). More specifically, fuel passes from the fuel line 501 into the housing first end 112a, and the input manifold 122a passes the fuel from the hollow first end 112a to the capillaries 118. The heating element 150 in the heat input area 115 heats the fuel passing through the capillaries 118 past the fuel's vaporization point to separate the fuel into fuel components while not igniting either of the fuel or the fuel components. The fuel components then pass from the capillaries 118 to the output manifold 122b, from the output manifold 122b to the hollow second end 112b of the housing 110, and from the housing second end 112b into the fuel system for the internal combustion engine 502 downstream of the housing first end 112a.

To ensure that the fuel is properly heated (i.e., not over-heated or significantly under-heated), the sensor 160 may determine temperature as set forth above and provide temperature data to the controller 165. The controller 165 may in turn adjust a heat output of the heating element 150 using the data from the sensor 160 and a target temperature.

A prototype inline gasoline converter in accordance with the description set forth above has been constructed and tested. The prototype converter converted the gasoline into lighter, more volatile molecules (as set forth above) that fueled the internal combustion engine. By adding the prototype converter to an internal combustion engine's fuel system, it was observed that the engine operated at a cooler temperature with the prototype converter, and also operated for a longer period of time than when the prototype converter was not included.

It is understood that while certain forms of this invention have been illustrated and described, it is not limited thereto except insofar as such limitations are included in the following claims and allowable functional equivalents thereof.

1. A fuel converter, comprising:
a housing having a hollow first end configured to be coupled to a fuel line, a hollow second end configured to be coupled to a fuel system downstream of said housing first end, a heat input area, a plurality of capillaries spaced about said heat input area, an input manifold providing passage between said hollow first end and said capillaries, and an output manifold providing passage between said capillaries and said hollow second end; each said capillary having a diameter that is smaller than a diameter of a channel defined by said hollow first end; and
a heating element in said heat input area for heating fuel passing through said capillaries past the fuel's vaporization point to separate the fuel into fuel components while not igniting either of the fuel or the fuel components.

2. The fuel converter of claim 1, further comprising:
a sensor determining a temperature of at least one of: fuel in at least one of said capillaries, fuel components in at least one of said capillaries, said heat input area of said housing, and said heating element; and
a controller in communication with said heating element and said sensor to adjust a heat output of said heating element using data from said sensor and a target temperature.

3. The fuel converter of claim 2, wherein said capillaries are formed in a conductive material surrounding said heat input area.

4. The fuel converter of claim 3, further comprising insulation around at least a portion of said housing.

5. The fuel converter of claim 4, wherein said capillaries are generally linear.

6. The fuel converter of claim 5, wherein said housing is generally cylindrical with a circular cross-section perimeter between said input and output manifolds.

7. The fuel converter of claim 1, wherein said capillaries are formed in a conductive material surrounding said heat input area.

8. The fuel converter of claim 1, wherein said housing includes metal surrounding said heat input area, and wherein said capillaries are formed in said metal.

9. The fuel converter of claim 1, wherein said heating element is removably positioned in said heat input area.

10. The fuel converter of claim 1, wherein said heating element is a resistive heating element.

11. The fuel converter of claim 1, further comprising insulation around at least a portion of said housing.

12. The fuel converter of claim 1, wherein said capillaries are generally linear.

13. The fuel converter of claim 12, wherein said housing is generally cylindrical with a circular cross-section perimeter between said input and output manifolds.

14. The fuel converter of claim 1, wherein said fuel is gasoline.

15. An inline fuel converter housing, comprising:
a hollow first end configured to be coupled to a fuel line;
a hollow second end configured to be coupled to a fuel system downstream of said housing first end;
a heat input area;
a plurality of capillaries spaced about said heat input area;
an input manifold providing passage between said hollow first end and said capillaries; and
an output manifold providing passage between said capillaries and said hollow second end;
wherein each said capillary has a diameter that is smaller than a diameter of a channel defined by said hollow first end; and
wherein said capillaries are formed in a conductive material surrounding said heat input area, whereby heat from said heat input area heats fuel passing through said capillaries past the fuel's vaporization point to separate the fuel into fuel components while not igniting either of the fuel or the fuel components.

16. The fuel converter housing of claim 15, wherein said capillaries are formed in a conductive material surrounding said heat input area.

17. The fuel converter housing of claim 16, wherein:
said capillaries are generally linear; and
said housing is generally cylindrical with a circular cross-section perimeter

18. A method of converting fuel into fuel components for use in powering an internal combustion engine, the method comprising the steps of:
(a) passing fuel from a fuel line into a housing having a hollow first end,
(b) passing the fuel from the hollow first end through a plurality of capillaries spaced about a heat input area, each said capillary having a diameter that is smaller than a diameter of a channel defined by said hollow first end, said capillaries being formed in a conductive material surrounding said heat input area;
(c) heating the fuel passing through said capillaries past the fuel's vaporization point to separate the fuel into fuel components while not igniting either of the fuel or the fuel components;
(d) passing the fuel components from said capillaries into a hollow second end of said housing; and
(e) passing the fuel components from said hollow second end into a fuel system downstream of said housing first end.

19. The method of claim 18, wherein:
an input manifold passes the fuel between said hollow first end and said capillaries;
an output manifold passes the fuel components between said capillaries and said hollow second end; and
a heating element in said heat input area heats the fuel passing through said capillaries.
